(19) United States
(12) Patent Application Publication
(10) Pub. No.: US 2025/0043090 A1
(43) Pub. Date: Feb. 6, 2025

(54) METHOD FOR PREPARING SILICONE FOAM

(71) Applicant: ELKEM SILICONES FRANCE SAS, Lyon (FR)

(72) Inventors: Alexandre LOUIS, Pierre-Benite (FR); Emmanuel POUGET, Bron (FR)

(21) Appl. No.: 18/719,889

(22) PCT Filed: Dec. 15, 2022
(86) PCT No.: PCT/FR2022/000132

§ 371 Date: Jun. 14, 2024

(30) Foreign Application Priority Data
Dec. 17, 2021 (FR) FR2113749

(51) Int. Cl. C08J 9/12; B29C 35/02; B29C 44/58; B29K 83/00; C08J 9/00

(52) U.S. Cl. CPC C08J 9/125; B29C 35/02; B29C 44/588; C08J 9/0052; C08J 9/0071; B29K 2083/00; B29K 2995/0037; C08J 2201/026; C08J 2203/10; C08J 2383/07

(57) ABSTRACT

A new process is described for preparing silicone foam, ideal for the manufacture of articles in the field of construction, transport, electrical insulation or household appliances, particularly as padding material for seats in the field of transport. This method includes a step (a) of preparing a silicone composition capable of forming a foam by releasing a gas, a step (b) including introducing the silicone composition into a closed mold, and a step (c) including allowing the silicone composition to crosslink and/or harden to obtain the silicone foam, the walls of the mold being permeable to gas at least during all or part of the step of crosslinking and/or hardening of said silicone composition.

### FIELD OF THE INVENTION

The present invention relates to the technical field of silicone foams. More precisely, the present invention aims to propose a novel method for preparing silicone foam.

### PRIOR ART

The expression “foam of silicone” or “silicone foam” designates a composition of organopolysiloxanes in the form of a foam. Silicone foam materials are known in various fields of application such as in thermal and/or acoustic insulation, the production of flexible seals, the use as damping elements, etc. These applications use the known properties of silicone elastomers such as thermal stability, good mechanical properties and flame resistance.

The transport industry in particular demands low density silicone foams which, however, have kept their excellent mechanical, heat resistance and fire resistance properties.

Silicone foams are well known in the prior art and their preparation has been described in a certain number of patents. In particular, patent application WO 2021/014058 describes organopolysiloxane compositions intended to generate, after crosslinking and/or curing, a low density silicone foam, i.e., less than 0.20 g/cm³, advantageously having good mechanical properties, excellent fire resistance and which do not release toxic fumes during their combustion.

The silicone foam described in WO 2021/014058 is obtained by a foaming reaction that generates hydrogen: in summary, a composition which crosslinks by polyaddition, comprising an organopolysiloxane carrying vinyl groups bonded to silicon, an organopolysiloxane containing hydrogen atoms bonded to silicon and water, is used. The water reacts with the organopolysiloxane containing the hydride function, thereby producing gaseous hydrogen and a silanol. The silanol then reacts with the organopolysiloxane containing the hydride function by a hydrogen condensation reaction, thereby generating a second molecule of gaseous hydrogen, while another polydiorganosiloxane carrying vinyl groups bonded to silicon will simultaneously react with another polydiorganosiloxane containing hydride functions by an addition reaction, participating thereby in the construction of the silicone foam network.

It has been observed that when foaming was carried out in a standard open mold, substantial defects could appear in the foam, in particular depressions under the block of foam, large bubbles in the foam itself, etc. Such deformations are not acceptable for industrial scale production of silicone foam articles.

Very few documents in the prior art describe the means and methods for carrying out a method for foaming a silicone foam.

European patent application EP 0495566, published in 1992, describes a method for preparing silicone foam, in which the precursor foam composition is introduced into a closed and sealed mold the volume of which is less than the volume that the foam would occupy in the open mold by at least 10%. According to the inventors in that application, that foaming under restrained conditions can improve the flame resistance of the foams. Nevertheless, a post-crosslinking step by hot annealing in the mold for several hours appears necessary. In addition, in a closed mold, the densities of the foams obtained are systematically higher than the densities of foams obtained in an open mold. However, in the transportation industry, it is preferable to obtain low density silicone foams.

The Japanese patent application JP 2004-123836 describes a method for the manufacture of a silicone foam in a closed mold under reduced pressure. According to that document, that method can be used to obtain uniform silicone foams with the desired density. However, such a method is complicated to carry out and the management of the mold seal is critical. Because hydrogen is a gas that is highly diffusive in air, a seal is not guaranteed.

The patent application US 2011/0074061 A1 describes a method for molding a silicone elastomer sponge, preferably in the form of a tube. According to that method, a silicone composition is introduced into and crosslinked in a closed mold, then the gas present in the cavity of the mold is released before opening the mold. That step for intermediate degassing means that damage such as breaking or splitting of the molded object during unmolding can be avoided. However, that degassing step occurs only after crosslinking of the silicone composition. Thus, it cannot have an effect on any defects appearing on the object at the time it is crosslinked. In addition, as is apparent for the embodiment described in US 2011/0074061 A1, the holes used for releasing the gas are located at the small ends of the tube and cannot be used to prevent the appearance of deformations on the essential surfaces of the tube such as the inner or outer surface.

Other documents regarding methods for molding foams exist in the prior art (for example the American U.S. Pat. No. 3,431,331), but they concern polyurethane foams. Compared with silicone foams, the crosslinking chemistry is completely different, but also the foaming reaction, the gases released during expansion, the crosslinking and foaming kinetics, etc., are also different.

The improved foaming methods described in the prior art cannot therefore be used to easily produce a low density silicone foam.

Thus, the objective of the present invention is to propose a novel method for preparing silicone foam that can be used to obtain low density blocks of foam which do not have any major defects as regards shape. Advantageously, this method for preparing silicone foam is easy to carry out and does not require an annealing step.

### SUMMARY OF THE INVENTION

Thus, the present invention concerns a method for preparing a silicone foam comprising the following steps:
a) preparing a silicone composition which is capable of forming a foam by releasing a gas;
b) introducing said silicone composition into a closed mold; and
c) allowing said silicone composition to crosslink and/or cure to obtain the silicone foam;
the walls of said mold being permeable to gas at least during all or part of the step for crosslinking and/or curing said silicone composition.

Furthermore, the present invention concerns an article produced from silicone foam that is capable of being obtained by the method as defined above, as well as the use of a closed mold the walls of which are permeable to gas for the manufacture of silicone foam.

### BRIEF DESCRIPTION OF THE FIGURES

FIG. 1 represents an embodiment of a mold in accordance with the present invention.

FIG. 2 represents four embodiments (2A, 2B, 2C and 2D) of the wall of a mold in accordance with the present invention.

FIG. 3 is a photograph of a block of silicone foam obtained in accordance with the comparative example.

FIG. 4 is a photograph of the mold used in the example in accordance with the invention.

FIG. 5 is a photograph of a block of silicone foam obtained in accordance with the example in accordance with the invention.

### DETAILED DESCRIPTION OF THE INVENTION

Unless indicated otherwise, all of the viscosities of the silicone oils considered in the present disclosure correspond to a value for dynamic viscosity at 25° C. termed “Newtonian”, i.e. the dynamic viscosity which is measured, in a manner which is known per se, with a Brookfield viscosimeter with a shear rate gradient that is sufficiently low for the measured viscosity to be independent of the rate gradient.

The present invention concerns a method for preparing a silicone foam. This method comprises a first step (a) which consists of preparing a silicone composition which is capable of forming a foam by releasing a gas. Compositions of this type are known in the literature.

In accordance with a preferred embodiment, the silicone composition that is capable of forming a silicone foam is a composition which crosslinks by polyaddition and which generates hydrogen during the foaming reaction. In accordance with this preferred embodiment, said silicone composition comprises:
at least one organopolysiloxane A having at least two C₂-C₁₂ alkenyl groups bonded to silicon per molecule,
at least one organopolysiloxane B having at least two SiH motifs per molecule,
a catalytically effective quantity of at least one hydrosilylation catalyst C, and
at least one pore-forming agent D comprising a hydroxyl group.

The organopolysiloxane A having at least two C₂-C₁₂ alkenyl groups bonded to silicon per molecule may preferably be a linear organopolysiloxane formed by:
at least two siloxyl motifs with the following formula: YₐR¹_{b}SiO_{(4-a-b)/2}, in which Y represents a C₂-C₁₂ alkenyl group, preferably a vinyl group; R¹ represents a monovalent hydrocarbon group containing from 1 to 12 carbon atoms, preferably selected from alkyl groups containing from 1 to 8 carbon atoms such as methyl, ethyl, propyl groups, cycloalkyl groups containing from 3 to 8 carbon atoms and aryl groups containing from 6 to 12 carbon atoms; a=1 or 2, b=0, 1 or 2 and the sum a+b=2 or 3, and
optionally, motifs with the following formula: R¹_{c}SiO_{(4-c)/2}

in which R¹ has the same meaning as above and c=2 or 3.

It should be understood in the above formulae that if several R¹ groups are present, they may be identical to or different from each other.

Preferably, said organopolysiloxanes A are oils with a dynamic viscosity comprised between 100 mPa·s and 100000 mPa·s, preferably between 100 mPa·s and 80000 mPa·s, and more preferably between 1000 mPa·s and 50000 mPa·s.

The linear organopolysiloxane A having at least two C₂-C₁₂ alkenyl groups bonded to silicon per molecule may preferably be essentially constituted by siloxyl motifs “D” selected from the group constituted by the siloxyl motifs R¹₂SiO_{2/2}, YR¹SiO_{2/2} and Y₂SiO_{2/2}, and by terminal siloxyl motifs “M” selected from the group constituted by the siloxyl motifs YR¹₂SiO_{1/2}, Y₂R¹SiO_{1/2} and R¹₃SiO_{1/2}. The symbols Y and R¹ are as described above.

Examples of terminal motifs “M” that may be cited are the trimethylsiloxy, dimethylphenylsiloxy, dimethylvinylsiloxy or dimethylhexenylsiloxy groups.

Examples of motifs “D” that may be cited are the dimethylsiloxy, methylphenylsiloxy, methylvinylsiloxy, methylbutenylsiloxy, methylhexenylsiloxy, methyldecenylsiloxy or methyldecadienylsiloxy groups.

Examples of linear organopolysiloxanes which may form an organopolysiloxane A in accordance with the invention are:
a poly(dimethylsiloxane) with dimethylvinylsilyl end groups;
a poly(dimethylsiloxane-co-methylphenylsiloxane) with dimethylvinylsilyl end groups;
a poly(dimethylsiloxane-co-methylvinylsiloxane) with dimethylvinylsilyl end groups; and
a poly(dimethylsiloxane-co-methylvinylsiloxane) with trimethylsilyl end groups.

Preferably, the organopolysiloxane A contains terminal dimethylvinylsilyl motifs and yet more preferably, the organopolysiloxane A is a poly(dimethylsiloxane) with dimethylvinylsilyl end groups.

Preferably, the organopolysiloxane compound A has a content by weight of alkenyl motifs comprised between 0.001% and 30%, preferably between 0.01% and 10%, preferably between 0.02% and 5%.

The silicone composition preferably comprises 40% to 80% by weight of organopolysiloxane A, yet more preferably 50% to 70% by weight of organopolysiloxane A. In accordance with one embodiment, the silicone composition does not comprise branched organopolysiloxanes or resins comprising C₂-C₁₂ alkenyl motifs.

The organopolysiloxane B is an organopolysiloxane having at least two SiH motifs per molecule. Thus, it is an organohydrogenopolysiloxane. Preferably, the compound B comprises at least three SiH motifs.

The organopolysiloxane B may advantageously be an organopolysiloxane comprising at least two, preferably at least three, siloxyl motifs with the following formula: H_{d}R²ₑSiO_{(4-d-e)/2}, in which R² represents a monovalent radical containing from 1 to 12 carbon atoms, d=1 or 2, e=0, 1 or 2 and d+e=1, 2 or 3;
and optionally other motifs with the following formula: R²_{f}SiO_{(4-f)/2},
in which R² has the same meaning as above, and f=0, 1, 2, or 3.

It should be understood that, if several groups R² are present in the above formulae, they may be identical or differ from each other.

Preferably, R² may represent a monovalent radical selected from the group constituted by alkyl groups containing 1 to 8 carbon atoms, optionally substituted by at least one halogen atom such as chlorine or fluorine, cycloalkyl groups containing from 3 to 8 carbon atoms and aryl groups containing from 6 to 12 carbon atoms. R² may advantageously be selected from the group constituted by methyl, ethyl, propyl, 3,3,3-trifluoropropyl, xylyl, tolyl and phenyl.

The symbol d is preferably equal to 1.

The organopolysiloxane B may have a linear, branched, or cyclic structure. The degree of polymerization is preferably greater than or equal to 2. In general, it is less than 5000. Preferably, the viscosity of the organopolysiloxane B is comprised between 1 mPa·s and 5000 mPa·s, more preferably between 1 mPa·s and 2000 mPa·s, and yet more preferably between 5 mPa·s and 1000 mPa·s.

In the case of linear polymers, these are essentially constituted by siloxyl motifs “D” selected from the motifs R²₂SiO_{2/2} and R²HSiO_{2/2}, and from terminal siloxyl motifs “M” selected from the motifs R²₃SiO_{1/2} and R²₂HSiO_{1/2}, where R² has the same meaning as above.

Examples of organohydrogenopolysiloxanes which may be compounds B in accordance with the invention are:
a poly(dimethylsiloxane) with hydrogenodimethylsilyl end groups;
a poly(dimethylsiloxane-co-methylhydrogenosiloxane) with trimethylsilyl end groups;
a poly(dimethylsiloxane-co-methylhydrogenosiloxane) with hydrogenodimethylsilyl end groups;
a poly(methylhydrogenosiloxane) with trimethyisilyl end groups; and
a cyclic poly(methylhydrogenosiloxane).

When the organohydrogenopolysiloxane B has a branched structure, it is preferably selected from the group constituted by silicone resins with the following formulae:
M′Q, in which the hydrogen atoms bonded to silicon atoms are carried by the groups M;
MM′Q, in which the hydrogen atoms bonded to silicon atoms are carried by a portion of the motifs M;
MD′Q, in which the hydrogen atoms bonded to silicon atoms are carried by the groups D;
MDD′Q, in which the hydrogen atoms bonded to silicon atoms are carried by a portion of the groups D;
MM′TQ, in which the hydrogen atoms bonded to silicon atoms are carried by a portion of the motifs M;
MM′DD′Q, in which the hydrogen atoms bonded to silicon atoms are carried by a portion of the motifs M and D;
and their mixtures,
in which M=siloxyl motif with formula R²₃SiO_{1/2}, M′=siloxyl motif with formula R²₂HSiO_{1/2}, D=siloxyl motif with formula R²₂SiO_{2/2}, D′=siloxyl motif with formula R²HSiO_{2/2}, T=siloxyl motif with formula R²₃SiO_{1/2} and Q=siloxyl motif with formula SiO_{4/2}, in which R² has the same meaning as above.

Preferably, the organopolysiloxane B has a content by weight of hydrogenosilyl functions Si—H comprised between 0.2% and 91%, more preferably between 3% and 80% and yet more preferably between 15% and 70%.

Advantageously, the molar ratio of the hydrogenosilyl functions Si—H of the organopolysiloxanes B to the alkene functions of the organopolysiloxanes A is comprised between 5 and 100, preferably between 10 and 90, more preferably between 15 and 65, and yet more preferably between 20 and 55.

The silicone composition in accordance with the invention preferably comprises from 1% to 20% by weight, and more preferably from 3% to 15% by weight, of organopolysiloxane B.

The hydrosilylation catalyst C may in particular be selected from compounds of platinum and rhodium, but also from silicones such as those described in the patent applications WO 2015/004396 and WO 2015/004397, germanium compounds such as those described in the patent applications WO 20160/75414 or complexes of nickel, cobalt or iron such as those described in the patent applications WO 2016/071651, WO 2016/071652 and WO 2016/071654. The catalyst C is preferably a compound derived from at least one metal belonging to the platinum group. These catalysts are well known. In particular, it is possible to use complexes of platinum and an organic product described in the patents U.S. Pat. Nos. 3,159,601, 3,159,602, 3,220,972 and the European patents EP 0 057 459, EP 0 188 978 and EP 0 190 530, complexes of platinum and vinyl organosiloxanes described in the patents U.S. Pat. Nos. 3,419,593, 3,715,334, 3,377,432 and 3,814,730.

Preferably, the catalyst C is a compound derived from platinum. In this case, the quantity by weight of catalyst C, calculated as the weight of metallic platinum, is in general comprised between 2 ppm and 400 ppm by weight, preferably between 5 ppm and 200 ppm, based on the total weight of the silicone composition.

Preferably, the catalyst C is a Karstedt's platinum catalyst.

The pore-forming agent D comprising a hydroxyl group may be selected from the group constituted by water, polyols, monofunctional alcohols, organosilanes containing at least one silanol group, organosiloxanes containing at least one silanol group, and their mixtures.

In accordance with a preferred embodiment, the pore-forming agent D is water. The water may be added directly to the silicone composition. Alternatively, the water may be introduced in the form of an aqueous emulsion, for example a direct oil-in-water silicone emulsion or a reverse water-in-oil silicone emulsion comprising a continuous oily silicone phase, an aqueous phase and a stabilizer. In accordance with one embodiment, the water is introduced via an emulsion of silicone oil in water with quantity of water of the order of 60% by weight. When the water is introduced into the silicone composition via an emulsion, the dispersion of water in the silicone composition and its stability on storage are improved.

In accordance with another embodiment, the pore-forming agent D is a polyol. Preferably, it is an organic polyol containing from 3 to 12 carbon atoms and comprising at least 2 hydroxyl groups per molecule. The polyol may be linear or branched, and it may optionally comprise one or more aromatic rings. Examples that may be cited are saturated polyhydric alcohols containing at least 2 hydroxyl groups per molecule, such as those described in U.S. Pat. No. 4,871,781. Examples of polyols that may be used as the pore-forming agent in accordance with the invention are:
diols, for example 1,2-ethanediol, 2,3-propanediol, 1,3-propanediol, 1,4-butanediol, 1,5-pentanediol and 1,6-hexanediol;
triols, for example 1,2,3-propanetriol and 2,2-bis-hydroxymethyl-butanol;
tetritols, for example erythritol and pentaerythritol;
pentitols, for example arabitol, xylitol, and methylpentitol;
hexitols, for example mannitol and sorbitol; and
cycloaliphatic polyols, for example cyclohexane diols, cyclohexane triols, and inositol.

In accordance with another embodiment, the pore-forming agent D is a monofunctional alcohol. Preferably, it is an organic alcohol containing from 1 to 12 carbon atoms and comprising a single hydroxyl group per molecule. The alcohol may be linear or branched, and it may optionally comprise one or more aromatic rings. Examples of monofunctional alcohols that may be used as a pore-forming agent in accordance with the invention are methanol, ethanol, n-propanol, isopropanol, n-butanol, 2-butanol, tert-butanol, n-octanol, benzyl alcohol, and their mixtures.

In accordance with yet another embodiment, the pore-forming agent D is an organosilane containing one or more silanol groups. These compounds may, for example, be represented by the following formula (1) or formula (2):

(R³)₃SiOH (1)

(R³)₂Si(OH)₂, (2)

in which R³ represents a monovalent radical selected from the group constituted by alkyl groups containing 1 to 8 carbon atoms, optionally substituted by at least one halogen atom such as chlorine or fluorine, cycloalkyl groups containing from 3 to 10 carbon atoms and aryl groups containing from 6 to 12 carbon atoms.

It should be understood that if several groups R³ are present in the above formulae, they may be identical or differ from each other.

Examples of organosilanes containing one or more silanol groups that may be used as a pore-forming agent in accordance with the invention are (CH₃)₃SiOH, (C₆H₅)SiOH, (CH₃) (C₆H₅)₂SiOH and (C₆H₅)₂Si(OH)₂.

In accordance with yet another embodiment, the pore-forming agent D is an organosiloxane containing one or more silanol groups. Preferably, it may be an organopolysiloxane compound formed by:
at least one siloxyl motif with the following formula: R³_{g}(OH)ₕSiO_{(4-g-h)/2}
in which R³ has the same meaning as above; g=0, 1 or 2, h=1 or 2, and the sum g+h=1, 2 or 3, and
optionally, motifs with the following formula: R³ᵢSiO_{(4-i)/2}
in which R³ has the same meaning as above and i=0, 1, 2 or 3.

The silicone composition may furthermore comprise other compounds, in particular:
at least one mineral filler, in particular silica, quartz, or a mixture thereof;
at least one heat resistance and/or fire resistance additive;
at least one diorganopolysiloxane gum;
a diorganopolysiloxane oil blocked at each end of its chain by a triorganosiloxy motif for which the organic radicals bonded to silicon atoms are selected from alkyl radicals containing from 1 to 8 carbon atoms;
a crosslinking inhibitor;
a base color;
optionally, other fillers.

In accordance with a preferred embodiment, the silicone composition comprises a mineral filler which is preferably a fumed silica or a precipitated silica. The silica type mineral fillers preferably have a specific surface area, measured in accordance with the BET methods, of at least 50 m²/g, in particular comprised between 50 m²/g and 400 m²/g, preferably more than 70 m²/g, a mean primary particle dimension of less than 0.1 μm (micrometer) and an apparent density of less than 200 g/liter. Highly preferably, the mineral filler is a fumed silica the specific surface area of which is comprised between 100 m²/g and 300 m²/g.

The silica type mineral fillers, preferably hydrophilic, may be incorporated as into the silicone composition as they are, or optionally be treated with a compatibilizing agent. In accordance with a variation, these silicas may optionally be treated with one or more organosilicon compounds, for example organosilane or organosilazane, which are regularly deployed for this use. These compounds include methylpolysiloxanes such as hexamethyldisiloxane, octamethylcyclotetrasiloxane, methylpolysilazanes such as hexamethyldisilazane, hexamethylcyclotrisilazane, tetramethyldivinyldisilazane, chlorosilanes such as dimethyldichlorosilane, trimethylchlorosilane, methylvinyldichlorosilane, dimethylvinylchlorosilane, alkoxysilanes such as dimethyldimethoxysilane, dimethylvinylethoxysilane, trimethylmethoxysilane. These compounds may be used alone or as a mixture (see French patents FR 1 126 884, FR 1 136 885, FR 1 236 505 and British patent GB 1 024 234). In accordance with a preferred embodiment, the silica is treated during mixing with all or a portion of the organopolysiloxane A in accordance with an in-situ method. In accordance with one advantageous embodiment, the silica is treated with one or more hexaorganodisilazanes. Yet more preferably, the silica is treated with hexamethyldisilazane, alone or as a mixture with divinyltetramethyldisilazane.

The silica may optionally be pre-dispersed in a silicone oil, in a manner such as to obtain a suspension. In particular, it is preferred to use a suspension of treated fumed silica, in particular treated with hexamethyldisilazane, in a polyorganosiloxane oil, in particular vinylated.

As an alternative or in addition, the silicone composition in accordance with invention may also contain at least one other mineral filler which is a quartz. It is preferably a natural ground quartz with a mean granulometry of less than 10 microns. The quartz may optionally be treated in order to improve its compatibility with the organopolysiloxanes.

In accordance with a preferred embodiment, the silicone composition contains a mixture of silica and quartz, with a ratio by weight between the quartz and the silica which is preferably comprised between 0.5 and 4, more preferably between 1 and 3.6, yet more preferably between 1.5 and 3.2, and yet more advantageously between 1.5 and 2.8.

Other mineral fillers may be envisaged, in particular packing fillers such as diatomaceous earth, calcium carbonate and/or kaolin, for example.

The silicone composition may optionally comprise at least one heat resistance and/or fire resistance additive. These heat resistance and/or fire resistance additives are well known to the person skilled in the art. It may advantageously be selected from the group constituted by: the salts, oxides and hydroxides of metals such as iron, titanium, aluminum, nickel and copper; the salts, hydroxides and oxides of rare earths such as cerium and lanthanum; organophosphorous compounds; platinum derivatives; carbon black; and silicates of calcium, aluminum and/or potassium such as mica and wollastonite, for example. It is also possible to cite hydrated mineral fillers, oxides or carbonates of calcium, magnesium or aluminum, such as magnesium hydroxide Mg(OH)₂, aluminum hydroxide Al(OH)₃, hydromagnesite with the empirical formula Mg₅(CO₃)₄(OH)₂·4H₂O, and calcium hydroxide. In accordance with another embodiment, it would be possible to add hollow glass microspheres to the silicone composition.

The silicone composition may optionally comprise at least one diorganopolysiloxane gum. Diorganopolysiloxane gums are linear polymers with a high molecular weight, with a viscosity of more than 1000 Pa·s at 25° C., preferably more than 2000 Pa·s, and for which the diorganopolysiloxane chain is essentially constituted by motifs with formula R₂SiO_{2/2} and blocked at each end by motifs with formula R₃SiO_{1/2}, the radical R representing an alkyl radical containing from 1 to 8 carbon atoms or an alkenyl radical containing from 2 to 6 carbon atoms. The presence, along the length of the diorganopolysiloxane chain, of small quantities of motifs other than R₂SiO_{2/2}, for example of RSiO_{3/2} and/or SiO_{4/2} motifs, in a proportion of at most 2% with respect to the number of R₂SiO_{2/2} motifs, is not excluded, however. Preferably, the diorganopolysiloxane gums comprise at least two C₂-C₁₂ alkenyl groups bonded to silicon. Advantageously, the diorganopolysiloxane gum has a content by weight of vinyl motifs of more than 0.3%, preferably more than 0.5%, more preferably comprised between 0.5% and 6%, yet more preferably between 0.5% and 4%, and yet more preferably between 1% and 3.5%.

When the silicone composition comprises a crosslinking inhibitor (or addition reaction retarder), this may be selected from the following compounds: an organopolysiloxane, advantageously cyclic, and substituted by at least one alkenyl, tetramethylvinyltetrasiloxane being particularly preferred, pyridine, phosphines and organic phosphites, unsaturated amides, alkylated maleates, and acetylenic alcohols, for example 1-ethynyl-1-cyclohexanol, 3-methyl-1-dodecyne-3-ol, 3,7,11-trimethyl-1-dodecyne-3-ol, 1,1-diphenyl-2-propyne-1-ol, 3-ethyl-6-ethyl-1-nonyne-3-ol and 3-methyl-1-pentadecyne-3-ol.

In accordance with one embodiment, the silicone composition comprises (by weight with respect to the total weight of the silicone composition):
a. 40% to 80% by weight of at least one organopolysiloxane A having at least two C₂-C₁₂ alkenyl groups bonded to silicon per molecule,
b. 1% to 20% of at least one organopolysiloxane B having at least two SiH motifs and preferably at least three SiH motifs per molecule,
c. 2 ppm to 400 ppm by weight of a hydrosilylation catalyst C selected from platinum compounds (quantity calculated by weight of platinum metal),
d. 0.3% to 2.5% by weight of a pore-forming agent D,
e. at least 3% by weight of a fumed silica for which the specific surface area is comprised between 100 m²/g and 300 m²/g,
f. at least 6% by weight of at least one mineral filler which is a ground quartz, and
g. 0.4% to 5, by weight of at least one heat resistance and/or fire resistance additive.

In accordance with another embodiment, the silicone composition comprises (by weight with respect to the total weight of the silicone composition):
a. 40% to 80% by weight of at least one organopolysiloxane A having at least two C₂-C₁₂ alkenyl groups bonded to silicon per molecule,
b. 1% to 20% by weight of at least one organopolysiloxane B having at least two SiH motifs and preferably at least three SiH motifs per molecule,
c. 2 ppm to 400 ppm by weight of a hydrosilylation catalyst C selected from platinum compounds (quantity calculated by weight of platinum metal),
d. 0.3% to 2.5% by weight of a pore-forming agent D,
e. 3% to 14% by weight of at least one mineral filler which is a fumed silica for which the specific surface area is comprised between 100 m²/g and 300 m²/g,
f. 6% to 25% by weight of at least one mineral filler which is a ground quartz,
g. 0.4% to 5% by weight of at least one fire resistance additive,
h. 0 to 3000 ppm by weight of a crosslinking inhibitor, and
i. 0 to 4, by weight of a diorganopolysiloxane gum comprising at least two C₂-C₁₂ alkenyl groups bonded to silicon.

Although the composition which crosslinks by polyaddition as described above is the preferred embodiment for the silicone foam in accordance with the present invention, other silicone compositions that are capable of forming a foam are entirely envisageable, provided that the composition releases a gas which can permit the foaming phenomenon. In accordance with one embodiment, the silicone composition contains a pore-forming agent which expands the material under the action of heat by decomposition with the release of gas, in particular in the case of azo-type derivatives, for example azodicarbonamide, which will allow the release of nitrogen, carbon dioxide and ammonia. In accordance with another embodiment, the silicone composition contains a pore-forming agent which expands the material under the action of heat by changing phase, typically liquid to gas, which is particularly the case with solvents with a low boiling point.

In accordance with one embodiment, the silicone composition in accordance with the invention may be prepared from a bi-component (or multi-component) system, characterized in that it is in two (or more) distinct parts intended to be mixed in order to form said silicone composition. In particular, in the case of preferred silicone compositions such as those described above, the silicone composition may be prepared from a bi-component system, characterized in that one of the parts comprises the catalyst C and does not comprise the organopolysiloxane B, while the other part comprises the organopolysiloxane B and does not comprise the catalyst C. Other multi-component systems may be provided in order to improve the storage period and/or to optimize the viscosity of each of the components. As an example, the silicone composition in accordance with the invention may be prepared from a tri-component system, characterized in that it is in three distinct parts intended to be mixed in order to form said silicone composition.

Mixing of the parts of said bi-component (or multi-component) system may typically take place at a temperature close to ambient temperature, i.e., between 10° C. and 40° C. An increase in the temperature of the silicone composition is sometimes observed during this mixing, depending on the type of mixer and the shear applied. If crosslinking or curing of the silicone foam is to be accelerated, mixing may be carried out at a higher temperature, advantageously between 40° C. and 70° C.

It is important to have a good quality of mixing in order to obtain a homogeneous silicone foam with good mechanical properties.

The method in accordance with the present invention furthermore comprises a step (b) consisting of introducing said silicone composition prepared during step (a) into a closed mold.

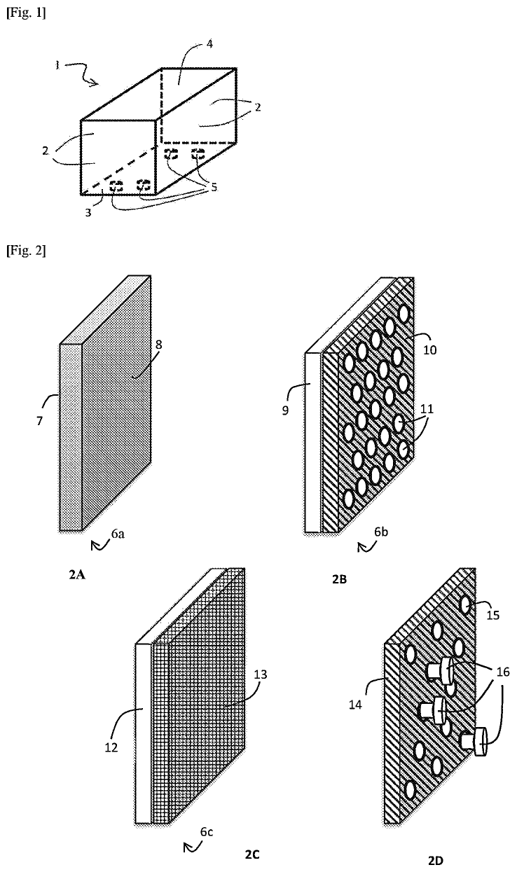

The closed mold defines a hollow volume corresponding to the shape of the article that is to be molded. The mold may have a simple geometric shape, for example a parallelepipedal shape, as illustrated in FIG. 1, or a complex shape corresponding to using the molded object, for example a seat with an ergonomic shape.

The dimensions of the mold may be selected by the user as a function of the article that is to be molded. The present method is particularly suitable for large-sized articles with a length and width typically comprised between 10 cm and 3 m, and a thickness of at least more than 2 cm, typically comprised between 5 cm and 30 cm, or between 10 cm and 20 cm.

Preferably, the bottom and top walls of the mold define the largest surfaces of the molded article, while the side walls define the thickness of the molded article.

In accordance with a first embodiment illustrated in FIG. 1, the mold (1) is constituted by side walls (2) (four side walls are shown here), a bottom wall (3) and a cover (4). The cover (4) constitutes the top wall of the mold (1). The bottom wall (3) is provided with feet (5) which act to support the mold. The cover (4) is preferably removable. When carrying out step (b) of the method in accordance with the present invention, the silicone composition may be cast or injected into the mold (1), then the cover (4) may be fixed to the side walls, thereby defining a closed hollow volume.

In accordance with another embodiment (not shown), the mold may be constituted by two half-molds that define a closed hollow volume when they are assembled. When carrying out step (b) of the method in accordance with the present invention, the silicone composition may typically be injected into the closed hollow volume defined by the two assembled half-molds.

The closed mold used in the present invention is characterized by its walls, which are permeable to gas at least during all or part of the step for crosslinking and/or curing of said silicone composition. Preferably, all of the walls of the mold in accordance with the invention are permeable to gas. The term “permeable to gas” as used in the present invention means the capacity for the material under consideration to allow the gas generated during the reaction for foaming the silicone composition in accordance with the present invention to pass through.

In accordance with one embodiment, all of the walls of the molds are constituted by the same material or materials. They are all permeable to gas during at least all of part of the step for crosslinking and/or curing of said silicone composition.

In accordance with another embodiment, the permeability of the mold is not homogeneous. As an example, it is possible to envisage an embodiment in which certain walls of the mold, typically the bottom wall (3) and the cover (4) in FIG. 1, are permeable to gas during all of part of the step for crosslinking and/or curing of said silicone composition, while the side walls (2) are less permeable, or even not permeable to gas during all or part of the step for crosslinking and/or curing of said silicone composition.

Furthermore, the walls have to be sufficiently rigid to ensure the mechanical strength of the mold and must be capable of containing the silicone composition in its liquid form before its crosslinking and/or curing reaction. The walls of the mold in accordance with the present invention are therefore both:
permeable to gas at least during all or part of the step for crosslinking and/or curing of said silicone composition,
impermeable to the silicone composition before its crosslinking and/or curing reaction, and
sufficiently rigid to ensure the mechanical strength of the mold.

Several embodiments may be envisaged by the person skilled in the art.

In a first embodiment, the walls of the mold in accordance with the invention are constituted by a rigid material to ensure the mechanical strength of the mold and is permeable to gas and impermeable to liquid. Such an embodiment is, for example, illustrated in FIG. 2A, the wall (6a) is constituted by a material with an inner face (7) and an outer face (8). This material is permeable to gas but impermeable to liquid. In addition, this material is sufficiently rigid to ensure the mechanical strength of the mold. As an example, it may be a composite microporous material or a plastic microporous material, such as a microporous PET.

In a second embodiment, the walls of the mold in accordance with the invention are constituted by two adjacent materials: a rigid outer material to ensure the mechanical strength of the mold, said outer material being a screen or a perforated plate, for example, in order to ensure the permeability to gas, and an inner material which is permeable to gas and impermeable to liquid. An embodiment of this type is illustrated in FIG. 2B and FIG. 2C by way of example: the wall (6b)/(6c) is constituted by a first material (9)/(12) defining the inside of the mold and by a second material (10)/(13) defining the outside of the mold. The first and second materials are both permeable to gas. The second material (10)/(13) can ensure the mechanical support function of the mold, while the first material (9)/(12) can ensure the impermeability to liquid. The second material (10)/(13) is rigid. It can ensure the mechanical strength of the mold. In order to ensure permeability to gas, the second material (10) is provided with perforations (11), as can be seen in FIG. 2B. The total surface area of the perforations may represent at least 30%, more preferably at least 40%, yet more preferably at least 50% of the total surface area of the second material (10). The second material (10) may be produced from a metal, for example steel or aluminum, from a rigid plastic, typically PET, polypropylene or indeed polycarbonate, or produced from a composite material. In FIG. 2C, the second material (13) is a screen or a metallic or plastic mesh. The first material (9)/(12) is preferably adjacent to the second material (10)/(13) and has the function of ensuring that the wall is impermeable to liquid. Preferably, it is a flexible material, typically a fibrous material. Said fibrous material may be of natural, artificial and/or synthetic origin. It may be a woven, knitted or nonwoven fibrous material. When it is a woven or knitted fibrous support, i.e., a woven fabric or a knitted fabric, the filaments are advantageously based on a thermoplastic polymer. Examples of suitable thermoplastic (co)polymers that may be cited are: polyolefins, polyesters, alkylene polyoxides, polyoxyalkylenes, polyhalogenoalkylenes, poly(alkylene phthalates or terephthalates), poly(phenyls or phenylenes), poly(oxides or phenylene sulfides), polyvinyl acetates, polyvinyl alcohols, polyvinyl halides, polyvinylidene halides, polyvinylnitriles, polyamides, polyimides, polycarbonates, polysiloxanes, acrylic or methacrylic acid polymers, polyacrylates or methacrylates, natural polymers such as cellulose and its derivatives, synthetic polymers such as synthetic elastomers, or thermoplastic copolymers comprising at least one monomer identical to any one of the monomers included in the aforementioned polymers, as well as mixtures and/or alloys of all of these (co)polymers. When the fibrous material is produced from a thermoplastic polymer, it is preferably produced from a polyester, such as polyethylene terephthalate (PET), polypropylene terephthalate (PPT), polybutylene terephthalate (PBT), their copolymers and blends, or from polyamide such as polyamide 6, polyamide 6.6, polyamide 4, polyamide 1.1, polyamide 1.2, polyamides 4-6, 6-10, 6-12, 6-36, 12-12, their copolymers and blends.

In a third embodiment, the walls of the mold in accordance with the invention are constituted by:
a rigid outer material to ensure the mechanical strength of the mold, provided with vents in order to ensure the permeability to gas, and
a removable device ensuring the impermeability of the wall to liquid.

The vent or vents may be disposed with a regular spacing in order to enable the gas to be released homogeneously on the wall of the mold. Their size and number may be adapted as a function of the quantity of gas generated during crosslinking and/or curing of the silicone composition. Preferably, the vent or vents may be disposed on the bottom wall of the mold, and optionally on the top wall of the mold, which preferably define the largest surfaces of the molded article.

An embodiment of this type is illustrated in FIG. 2D, for example; the wall (14) is constituted by a rigid material ensuring the mechanical strength of the mold, and provided with vents (15) ensuring the permeability to gas. To ensure the impermeability to liquid, the wall is provided with plugs (16) that are adapted to the vents (15). When the silicone composition is introduced into the mold in the liquid form, the plugs (16) are disposed in the vents (15). When the crosslinking and/or curing reaction commences, the silicone composition will reach a gel point beyond which it will no longer be sufficiently fluid to pass through the wall. From this moment on, the plugs (16) are removed in order to enable the evacuation of gas during the remainder of the crosslinking and/or curing reaction. As an alternative, the removable device ensuring the impermeability of the wall to liquid may be a removable panel, an outer impermeable adhesive film, etc.

The method in accordance with the present invention finally comprises a step (c) consisting of allowing said silicone composition to crosslink and/or cure to obtain the silicone foam. This step (c) may vary in duration, as a function of the silicone composition and of the temperature of step (b). In general, a silicone foam with good properties is obtained after a few minutes or a few hours, depending on the temperature and the concentration of catalyst and inhibitor in the silicone composition.

The crosslinking and/or curing of the silicone composition is firstly characterized by obtaining a gel. The gel point of the composition is defined as the stage at which the liquid starts to have pseudo-elastic characteristics. In the technical field of polymers, the gel point can be defined as being the point of inflexion of the viscosity-time curve. In practice, the gel point of the composition may be determined visually by the person skilled in the art. Beyond the gel point, the silicone composition continues to crosslink and/or cure in order to obtain the silicone foam.

In the method in accordance with the present invention, the walls of the mold are preferably permeable to gas after the gel point of said silicone composition. Before the gel point, the walls of the mold may be permeable or impermeable to gas, depending on the mold used.

In accordance with one embodiment of the present invention, the method for preparing a silicone foam comprises the following steps:
a) preparing a silicone composition which is capable of forming a foam by releasing a gas;
b) introducing said silicone composition into a closed mold wherein the walls of the mold are constituted by two adjacent materials: a rigid outer material to ensure the mechanical strength of the mold and is permeable to gas, said outer material being a screen or a perforated plate, for example, and an inner material which is permeable to gas and impermeable to liquid;
c) allowing said silicone composition to crosslink and/or cure to obtain the silicone foam.

In accordance with another embodiment of the present invention, the method for preparing a silicone foam comprises the following steps:
a) preparing a silicone composition which is capable of forming a foam by releasing a gas;
b) introducing said silicone composition into a closed mold wherein the walls of the mold are constituted by a rigid outer material to ensure the mechanical strength of the mold and the permeability to gas, and by a removable device ensuring the impermeability of the wall to liquid;
c) allowing said silicone composition to crosslink and/or cure to the gel point;
c′) removing the removable device ensuring the impermeability of the wall to liquid; and
c″) allowing said silicone composition to crosslink and/or cure to obtain the silicone foam.

Advantageously, the entire method for manufacturing the silicone foam is carried out with a flush of air or nitrogen in order to avoid the risks associated with the release of hydrogen during the method. In addition, the method for the manufacture of the silicone foam is preferably carried out at atmospheric pressure and at ambient temperature, also in order to avoid the risks associated with the release of hydrogen. The ambient temperature is generally comprised between 15° C. and 40° C., typically approximately 25° C. In addition to safety considerations, the fact of carrying out the method at atmospheric pressure and/or at ambient temperature is a major advantage in terms of simplifying the technology and of implementation costs.

The method in accordance with the present invention may optionally comprise an additional step (d) consisting of annealing the silicone foam obtained in step (c). This optional annealing step may consist of a heat treatment with a duration of 1 to several hours, preferably 1 to 4 hours, at a temperature comprised between 50° C. and 200° C., preferably between 100° C. and 150° C. It can if necessary improve the fire resistance and the mechanical properties of the silicone foam. However, this step is not indispensable, and a method for preparing a silicone foam in accordance with the invention characterized in that it does not comprise an additional annealing step is preferred.

After crosslinking and/or curing, and optional annealing, a silicone foam is obtained and it can be unmolded. Advantageously, the material of the inner face of the mold, i.e. the material in contact with the silicone composition before it is crosslinked and/or cured, then in contact with the silicone foam after it is crosslinked and/or cured (for example, the material of the inner face (7) of the first embodiment or the first materials (9) and (12) of the second and third embodiments described above) is selected in a manner such that unmolding is easy. To this end, the material is selected from materials which have little or no adhesion to the silicone foam after it has been crosslinked and/or cured. Preferably, the material of the inner face of the mold is produced from polyester. Alternatively, the material may be surface-treated in order to improve its non-adhesion to the silicone foam, for example with a fluorocarbon coating.

The present invention also concerns an article produced from silicone foam obtained by the method as defined above. This silicone foam article advantageously does not have any significant shape defects. In particular, it does not have any deformations or depressions on its bottom face. The foam advantageously reproduces the shape predefined by the hollow volume of the mold used.

Furthermore, the foam obtained by the method of the present invention advantageously has a low density, preferably less than 0.20 g/mL, more preferably less than 0.17 g/mL, yet more preferably less than 0.14 g/mL. It is visually uniform with a homogeneous distribution of the sizes of the bubbles in the foam and does not contain large bubbles the diameter of which is greater than equal to 2 mm.

Finally, the properties of heat resistance and fire resistance of the silicone foam obtained by the method of the present invention are excellent, because of the nature of the silicone composition used. The foam advantageously does not give off toxic fumes during its combustion.

The advantages presented above therefore ensure that the silicone foam obtained by the method of the present invention forms an ideal material for the manufacture of articles in the construction, transportation, electrical insulation or household appliance sectors, more particularly as upholstery material for seats in the transportation sector. Thus, the silicone foam article is preferably at least one element of a seat in the transportation sector.

Other details or advantages of the invention will become more apparent from the examples given below purely by way of indication.

### Examples

A silicone composition which is capable of forming a foam and crosslinking by polyaddition was prepared by mixing the compounds described in Table 1 below at ambient temperature:

TABLE 1

| | | % by weight |
|---|---|---|
| Organopolysiloxane | Poly(dimethylsiloxane) blend | 56.2 |
| A | with dimethylvinylsilyl end | |
| | groups, viscosity = 3500 to 20000 | |
| | mPa · s | |
| Organopolysiloxane | Poly(methylhydrogenosiloxane) | 12 |
| B | with trimethylvinylsilyl end | |
| | groups, viscosity = 30 mPa · s | |
| Catalyst C | Karstedt's platinum catalyst | 0.04 |
| Pore-forming agent | Silicone emulsion containing | 1.16 |
| D | approximately 59.5% by weight of | |
| | water | |
| Silica | Fumed silica with a specific | 9.4 |
| | surface area of 300 m²/g treated | |
| | with a mixture of | |
| | hexamethyldisilazane and | |
| | divinyltetramethyldisilazane | |
| Quartz | Ground quartz in which half of | 15 |
| | the particles have a size of less | |
| | than or equal to 4 microns | |
| Organopolysiloxane | Diorganopolysiloxane gum | 1.5 |
| gum | essentially constituted by | |
| | dimethylsiloxane and | |
| | methylvinylsiloxane motifs | |
| | comprising 2.4% by weight of | |
| | vinyl motifs | |
| Heat resistance | Mixture of titanium oxide, mica | 3.7 |
| and fire resistance | and cerium hydroxide | |
| additive | | |
| Crosslinking | Solution containing 1% of | 1.0 |
| inhibitor | ethynylcyclohexanol in a | |
| | polydimethylsiloxane oil blocked | |
| | by (CH₃)₂(Vi)SiO_{1/2} motifs with a | |
| | viscosity of 600 mPa · s at 25° C. | |

### Comparative Example

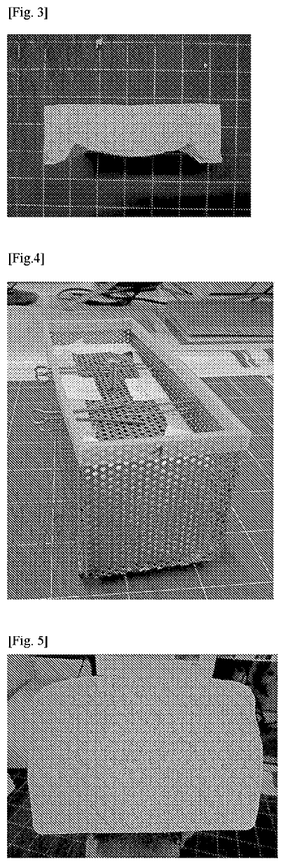

The silicone composition obtained after mixing was cast into a parallelepipedal mold without a cover, with dimensions of 27×17×11 cm, in which the side and bottom walls were produced from polypropylene (impermeable to gas). After 45 minutes at 23° C., the foam obtained was unmolded. As can be seen in FIG. 3, the foam block exhibited substantial deformation, in particular on its bottom face. The density of the foam was 0.150 g/mL.

### Example in Accordance with the Invention

The same silicone composition was cast into a mold in accordance with the invention constituted by a perforated steel frame with dimensions of 55×20×20 cm, the inner walls of which had been covered with a polyester fabric. A cover, also constituted by a plate of perforated steel covered with a polyester fabric, was fixed on the frame in a manner such as to form a closed mold which was permeable to gas (FIG. 4). After 45 minutes at 23° C., the foam obtained was unmolded. As can be seen in FIG. 5, the block of foam obtained in accordance with the present invention did not have any major deformations. The shape of the block corresponded perfectly to the shape defined by the mold. The density of the foam was 0.135 g/mL.

1. A method of preparing a silicone foam, the method comprising the following steps:
a) preparing a silicone composition that can form a foam by releasing a gas;
b) introducing said silicone composition into a closed mold; and
c) allowing said silicone composition to crosslink and/or cure to obtain the silicone foam;
the walls of said mold being permeable to gas during all or at least part of the step c) crosslinking and/or curing of said silicone composition.

2. The method of preparing a silicone foam as claimed in claim 1, wherein the silicone composition that can form a silicone foam is a composition which crosslinks by polyaddition, and comprises:
at least one organopolysiloxane A having at least two C₂-C₁₂ alkenyl groups bonded to silicon per molecule,
at least one organopolysiloxane B having at least two SiH motifs per molecule,
a catalytically effective quantity of at least one hydrosilylation catalyst C, and
at least one pore-forming agent D comprising a hydroxyl group.

3. The method of preparing a silicone foam as claimed in claim 2, wherein the pore-forming agent D comprising a hydroxyl group is selected from the group consisting of water, polyols, monofunctional alcohols, organosilanes comprising at least one silanol group, organosiloxanes comprising at least one silanol group, and their mixtures.

4. The method of preparing a silicone foam as claimed in claim 2, wherein the silicone composition comprises (by weight with respect to the total weight of the silicone composition):
a. about 40% to about 80% by weight of at least one organopolysiloxane A having at least two C₂-C₁₂ alkenyl groups bonded to silicon per molecule,
b. about 1% to about 20% of at least one organopolysiloxane B having at least two SiH motifs and optionally at least three SiH motifs per molecule,
c. about 2 ppm to about 400 ppm by weight of a hydrosilylation catalyst C selected from platinum compounds (quantity calculated by weight of platinum metal),
d. about 0.3% to about 2.5% by weight of a pore-forming agent D,
e. at least about 3% by weight of a fumed silica the specific surface area of which is from about 100 m²/g to about 300 m²/g,
f. at least about 6% by weight of at least one mineral filler which is a ground quartz, and
g. about 0.4% to about 5% by weight of at least one heat resistance and/or fire resistance additive.

5. The method of preparing a silicone foam as claimed in claim 1, wherein the walls of the mold are comprised of a rigid material to ensure mechanical strength of the mold, permeability to gas and impermeability to liquid.

6. The method of preparing a silicone foam as claimed in claim 1, wherein the walls of the mold are comprised of two adjacent materials: a rigid outer material to ensure mechanical strength of the mold, and permeability to gas, said outer material optimally being a screen or a perforated plate to ensure permeability to gas, and an inner material which is permeable to gas and impermeable to liquid.

7. The method of preparing a silicone foam as claimed in claim 6, wherein the inner material which is permeable to gas and impermeable to liquid is a flexible material.

8. The method of preparing a silicone foam as claimed in claim 6, the method comprising the following steps:
a) preparing the silicone composition that can form a foam by releasing a gas;
b) introducing said silicone composition into the closed mold wherein the walls of the mold are constituted by two adjacent materials: a rigid outer material to ensure mechanical strength of the mold and permeability to gas, said outer material optionally being a screen or a perforated plate to ensure permeability to gas, and an inner material which is permeable to gas and impermeable to liquid; and
c) allowing said silicone composition to crosslink and/or cure to obtain the silicone foam.

9. The method of preparing a silicone foam as claimed in claim 1, wherein the walls of the mold are comprised of a rigid outer material to ensure mechanical strength of the mold, and are provided with vents to ensure permeability to gas, and include a removable device ensuring impermeability of the walls to liquid.

10. The method of preparing a silicone foam as claimed in claim 9, the method comprising the following steps:
a) preparing the silicone composition that can form a foam by releasing a gas;
b) introducing said silicone composition into the closed mold wherein the walls of the mold are comprised of a rigid outer material to ensure mechanical strength of the mold and permeability to gas, and include a removable device ensuring impermeability of the walls to liquid;
c) allowing said silicone composition to crosslink and/or cure to a gel point;
c′) removing the removable device ensuring the impermeability of the walls to liquid; and
c″) allowing said silicone composition to crosslink and/or cure to obtain the silicone foam.

11. The method of preparing a silicone foam as claimed in claim 1, wherein the method is carried out at atmospheric pressure.

12. The method of preparing a silicone foam as claimed in claim 1, wherein the method is carried out at ambient temperature.

13. An article produced from silicone foam that is obtained by the method as defined in claim 1.

14. The silicone foam article as claimed in claim 13, wherein the article is an article in the construction, transportation, electrical insulation or household appliance sectors.

15. A method of making a silicone foam, the method comprising forming the foam using a closed mold wherein the walls of the mold are permeable to gas for the manufacture of the silicone foam.

16. The method of making a silicone foam according to claim 3, wherein the pore-forming agent D is water.

17. The method of making a silicone foam according to claim 7, wherein the flexible material is a woven, knitted or nonwoven fibrous material.

18. The silicone foam article according to claim 14, wherein the article is at least one element of a seat in the transportation sector.
